(19) United States
(12) Patent Application Publication
(10) Pub. No.: US 2025/0314852 A1
(43) Pub. Date: Oct. 9, 2025

(54) PRISMS FOR CAMERA MODULES

(71) Applicant: Apple Inc., Cupertino, CA (US)

(72) Inventors: Takeyoshi Saiga, Tokyo-to (JP); Yoshikazu Shinohara, Cupertino, CA (US)

(21) Appl. No.: 19/080,076

(22) Filed: Mar. 14, 2025

Related U.S. Application Data
(60) Provisional application No. 63/631,867, filed on Apr. 9, 2024.

(51) Int. Cl. G02B 7/18; G02B 13/00; G02B 27/00; G03B 17/17; H04N 23/55

(52) U.S. Cl. CPC G02B 7/1805; G02B 13/0065; G02B 27/0018; G03B 17/17; H04N 23/55

(57) ABSTRACT

Embodiments described herein relate to camera modules which include a prism, and a lens assembly and image sensor positioned adjacent to a common side of the prism. The camera module may be configured such that the light enters the prism (e.g., from the lens assembly) via a first surface and exits the prism (e.g., directed to the image sensor) via the same, first surface. The prism may be operable to move with respect to both the lens assembly and the image sensor via an actuator. The prism may include opaque masks extending from a second surface that is opposite the first surface and into the body of the prism. The structure described can help reduce the overall package size of the camera module due to the configuration of the prism.

### CROSS-REFERENCE TO RELATED APPLICATION(S)

This application is a nonprovisional patent application of and claims the benefit of U.S. Provisional Patent Application No. 63/631,867, filed Apr. 9, 2024 and titled “Prisms for Camera Modules,” the disclosure of which is hereby incorporated herein by reference in its entirety.

### TECHNICAL FIELD

Embodiments described herein relate to camera modules, and in particular, to camera modules in which light is directed into and collected from a common surface of a prism.

### BACKGROUND

Most consumer electronics devices, such as smartphones, tablets, and computers, include cameras. As new generations for consumer electronic devices are released, improvements on the quality and/or capabilities of the cameras are needed. As electronic devices continue to shrink in size, optical systems increase in complexity to provide the same or improved performance in a smaller package size. One way to decrease the package size of an optical system along one or more dimensions is to use folding optics, such as a prism, to fold light along one or more additional axes from an initial axis along which light enters the optical system. While the use of prims may help to reduce the footprint of a camera along one or more dimensions, there is a continuing need to reduce the size of cameras while improving performance.

### SUMMARY

Embodiments described herein relate to camera modules that include prisms. Some embodiments are directed to a camera module including a prism, a lens assembly, an image sensor, and an actuator. The prism may include a body formed from an optically transparent material. The body may define a first surface and a second surface opposite the first surface. The lens assembly may be positioned to direct light from a scene to the first surface of the body. The image sensor may be positioned to receive light directed through the prism that exits from the first surface of the body. The actuator may be coupled to the prism and may be configured to move the prism relative to both the lens assembly and the image sensor.

In some variations, the body may also define a third surface oblique to the first and second surfaces, the third surface connecting the first surface to the second surface; and a fourth surface oblique to the first and second surface. In some cases, the third and fourth surfaces are configured to reflect light traveling through the prism. In some examples, the third surface is oblique to the fourth surface.

In some variations, the prism further includes a first opaque mask extending into the body from the second surface. In some examples, the prism includes a plurality of opaque masks, where the plurality of opaque masks includes the first opaque mask, and each opaque mask of the plurality of opaque masks extends towards the body from the second surface of the prism.

In some examples described herein, the actuator includes a voice coil motor. In yet other examples, the optically transparent material includes glass.

Some embodiments described herein are directed to a camera module having a prism, a lens assembly, and an image sensor. The prism may include a body formed from an optically transparent material, the body defining a first surface, and a second surface opposite the first surface. Further, the prism may include an opaque mask extending into the body from the second surface. The lens assembly may be configured to direct light from a scene to the first surface of the body. The image sensor configured to receive light directed through the prism that exits from the first surface of the body.

In some cases, the opaque mask described herein has a rectangular shape. In some variations, the opaque mask is a first opaque mask, the prism further includes a second opaque mask and a third opaque mask, each the first and the second opaque masks extend into the body from the second surface, and the first, second, and third opaque masks are laterally spaced along the second surface. In some examples, the body defines a third surface oblique to the first and second surface, and a fourth surface oblique to the first and second surfaces. In this example, the third surface is positioned such that light entering the first surface from the lens assembly is directed toward the third surface. The first opaque mask may be positioned between the third surface and the second opaque mask and the third opaque mask may be positioned between the second opaque mask and the fourth surface.

In some cases, a height of a portion of the second opaque mask is less than a respective height of each of a portion of the first opaque mask and a portion of third opaque masks. Under some examples, the first opaque mask defines a central portion and a peripheral portion and the central portion has a height less than a height of the peripheral portion. The height of the peripheral portion may be the same height as the body.

A camera module described herein may include a lens assembly, an image sensor, and a prism. The prism may be positioned to receive light from a scene via the lens assembly and to transmit light through the prism to the image sensor. The prism may define a first surface, a second surface opposite the first surface, a third surface oblique to the first and second surfaces, and a fourth surface oblique to the first and second surfaces. The prism may be configured such that, when the light is received from the lens assembly, the light enters the prism through the first surface, reflects from the third surface toward the first surface, reflects from the first surface toward the fourth surface, reflects from the fourth surface toward the first surface, and exits the prism through the first surface.

In some cases, at least a portion of a periphery of the first surface is covered by an opaque coating. In some examples, the opaque coating is a first opaque coating and the prism further includes a second opaque coating covering the second surface. In some embodiments, the prism also includes a first reflective coating covering at least a first portion of the third surface of the prism and a second reflective coating covering at least a first portion of the fourth surface of the prism. The prism may also include a third opaque coating covering a second portion of the third surface of the prism and at least partially surrounding the first reflective coating and a fourth opaque covering a second portion of the fourth surface of the prism and at least partially surrounding the second reflective coating. In some cases, a body of the prism may define the first, second, third, and fourth surfaces and a plurality of opaque masks may extend towards the body from the second surface of the prism between the third and fourth surfaces.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1A shows a rear view of an example electronic device which may include one or more camera modules that incorporate a prism, such as described herein.

FIG. 1B shows a block diagram illustrating components of the example electronic device, such as described herein.

FIG. 2 shows an elevation view of a camera module with a prism.

FIG. 3A shows an elevation view of an example camera module described herein that has a lens assembly and an image sensor positioned to a common side of a prism.

FIG. 3B shows a bottom view of the trapezoidal prism from FIG. 3A. FIG. 3C shows a plan view of the prism from FIG. 3A.

FIG. 4A shows a cross-sectional view of an example camera module including a prism with multiple opaque masks extending into the prism from a common surface. FIG. 4B shows a perspective view of the prism from FIG. 4A.

FIGS. 4C-4E show a cross-sectional view of opaque masks that may be part of the prism from FIG. 4A.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to camera modules with a lens assembly, an image sensor, and a prism, in which the lens assembly and the image sensor are positioned adjacent to a common side of the prism. The prism may be coupled to an actuator that moves the prism with respect to both the lens assembly and/or the image sensor, thereby allowing the camera to incorporate autofocusing capabilities in a smaller footprint. In some cases, the prism includes one or more opaque masks that extend into a body of the prism and that help to control light passing through the prism (e.g., by blocking stray light). The opaque mask or masks may be configured to block stray light within the prism to reduce flare.

Prisms may be used in camera modules to reduce the size of the camera without reducing the focal length and/or overall camera capabilities. One use of prisms in cameras is as a light-folding component of an optical assembly. For example, a camera module may include a lens assembly that is arranged to collect light from a scene (e.g., a user taking a picture of the environment around the camera module). The collected light then enters a prism, which folds the light multiple times and along different optical paths, before reaching an image sensor. This may reduce the package size of an optical system along one or more dimensions while maintaining a focal length of the optical assembly. For example, a camera module may incorporate a prism, whereby light entering the prism is configured to reflect off of different surfaces of the prism (and thereby fold light along one or more additional axes) before exiting the prism. In some instances, a camera module is designed such that light will reflect off one or more surfaces using total internal reflection. In these instances, these surfaces may not be covered by a reflective coating (e.g., a mirror coating), such that it may be possible for light to exit the prism through these surfaces.

A prism described herein may reduce the package size of the camera module. In some examples, a camera module may be configured such that both a lens assembly and an image sensor is positioned adjacent to a common surface of the prism. More specifically, the prism may define two opposite faces, each face having a respective surface (e.g., a first surface corresponding to a first face of the prism and second surface corresponding to the second face of the prism) and two faces which define oblique surfaces (e.g., a third surface and fourth surface). Because the lens assembly and the image sensor are positioned adjacent to a common side of the prism, the light can enter the prism through a first surface of the common side, reflects off two or more surfaces (e.g., the oblique surfaces and/or the first surface again), and exits through the same, first surface. In some cases, the prism may be coupled to an actuator, which can be operable to move the prism in at least a direction perpendicular to the first surface (e.g., towards and away from both the lens assembly and the image sensor). Due to both the lens assembly and the image sensor being positioned adjacent a common side, the prism can be configured to move simultaneously away from the lens assembly and the image sensor which results in a shorter travel distance of the prism for an equivalent change in focal length of the camera.

In some embodiments, the prism may be configured such that light may enter, reflect, and exit from the same surface (e.g., the first surface). For example, light may first enter the prism via a region of the first surface. Once inside the prism, light may travel through and reflect from a first oblique surface. This first oblique surface, in turn, reflects the light back to the first surface. At the first surface, light may bounce again (e.g., via total internal reflection) and reach a different, second oblique surface. Afterwards, light reflects from the second oblique surface and reach the first surface again before exiting the prism.

The prism may include a body. The body of the prism may be formed from an optically transparent material and may be configured to transmit light within the prism. The body of the prism may define the size and shape of the prism. For example, the body may define the external surfaces of the prism and/or the surface of the prism through which light enters, reflects, and exits from the prism.

Under some examples, the prism may additionally include an opaque mask that is positioned to extend into the body of the prism. The opaque mask may extend from a surface of the prism opposite the first surface (e.g., a second surface), into the body, and towards the first surface. The opaque mask is optically absorptive (e.g., formed from one or more optically absorptive materials) such that light incident to it (e.g., stray light) may be blocked or absorbed by the opaque mask. In some cases, the prism may include multiple opaque masks separated laterally along the second surface. Each of the opaque masks may extend towards the first surface. In some examples, the opaque masks extend perpendicularly with respect to the second surface. In other examples, the opaque masks extend obliquely with respect to the second surface, in a general direction towards the first surface.

In some cases, the dimensions and/or shape of some of the opaque masks may be different from each other. For example, one or more opaque masks may have a shape in which different portions of the masks have different heights relative to the second surface. For example, a mask may have a central portion and one or more peripheral portions (e.g., defining a “U” shape), where the central portion has a smaller height than the height(s) of the peripheral portions Additionally or alternatively, one or more opaque masks may have a rectangular shape. Due to the shape of the prism and the configuration of the multiple opaque masks, the second surface may not be configured to reflect any light. In some examples. The surfaces of the prism includes opaque coatings and/or reflective coatings as desired that help absorb and/or help reflect, respectively, light incident upon each surface.

As described herein, “optically absorptive” and “optically transparent” are used in the context of imaging capabilities of the camera. For example, the camera modules described herein may be configured to capture and measure light at one or more wavelengths. For example, some camera modules are configured to measure light at visible wavelengths (e.g., to capture RGB images). Additionally or alternatively, a camera module may be configured to measure light at one or more infrared wavelengths. Accordingly, while these cameras may be exposed to light of a wide range of wavelengths, the images captured by these cameras will only reflect a particular set of wavelengths (also referred to herein as the “operating wavelength range” of the camera module).

Accordingly, when an optical component of a camera module is described herein as being “optically transparent”, it should be appreciated that this optical component is transparent for at least the operating wavelength range of the camera. In this way, a given optical component (e.g., a lens) will be able to route light within the operating wavelength range to an image sensor. These components may be transparent at additional wavelengths, but need not be.

Similarly, when an optical component of a camera module is described herein as a being “optically absorptive”, this component is configured to absorb light having a wavelength with the operating wavelength range of the camera. An “optically absorptive” may refer to materials which absorb light having a wavelength with the operating wavelength range of the camera. For example, an optically absorptive material may absorb light in the visible range, in the infrared range, combinations thereof, or the like, depending on the operating wavelength range of a given camera module. Optically absorptive components may optionally absorb light at additional wavelengths beyond those included in the operating wavelength range of the camera module.

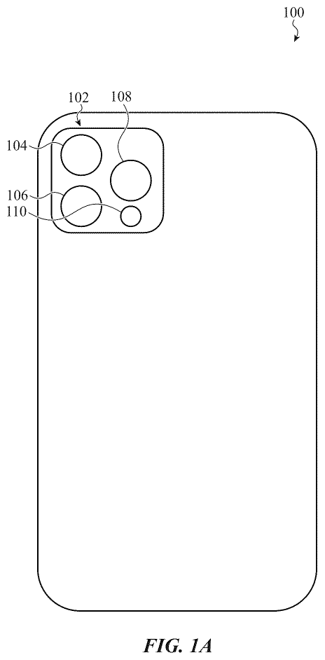

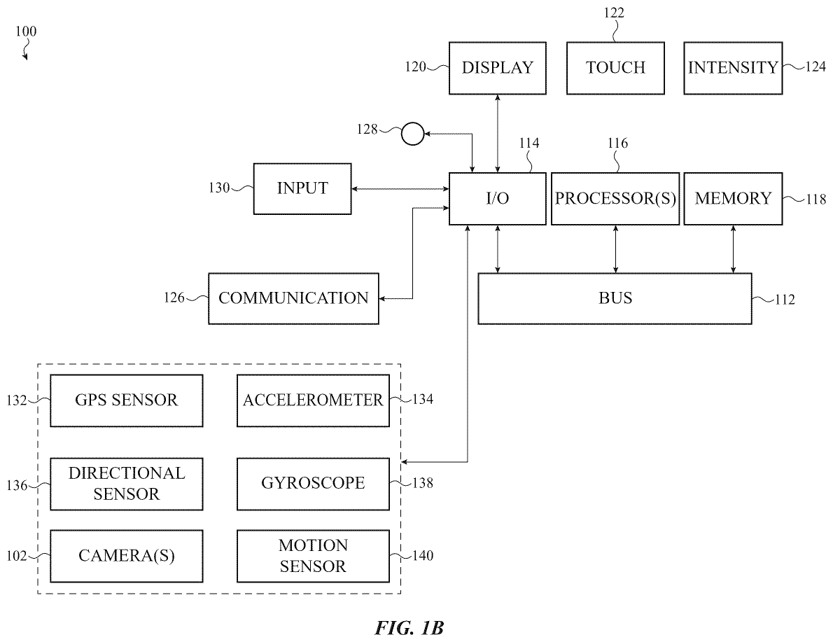

These foregoing and other embodiments are discussed below with reference to FIGS. 1A-4E. However, those skilled in the art will readily appreciate that the detailed description given herein with respect to these figures is for explanation only and should not be construed as limiting.

FIG. 1A shows a rear view of an electronic device 100 which may incorporate one or more cameras that utilize examples of the camera module described herein. The electronic device 100 may include multiple camera modules, such as a first camera module 102, a second camera module 104, and a third camera module 106. While three camera modules are depicted, it should be appreciated that the electronic device 100 may include more or fewer camera modules (including, for example, one or more camera modules on a front or other surface of the camera module). Some or all of the camera modules 102, 104, 106 may include an optical assembly having a prism as described in more detail herein.

The electronic device may optionally include a flash module 108, a depth sensor 110, and so on. The flash module 108 may provide illumination to some or all of the fields of view of the camera module(s) of the device. This may assist with image capture operations in low light settings. Additionally or alternatively, the device 100 may further include the depth sensor 110 that may calculate depth information for a portion of the environment around the device 100. Specifically, the depth sensor 110 may calculate depth information within a field of coverage (i.e., the widest lateral extent to which the depth sensor 110 is capable of providing depth information). The field of coverage of the depth sensor 110 may at least partially overlap the field of view of one or more of the optical assemblies. The depth sensor 110 may be any suitable system that is capable of calculating the distance between the depth sensor 110 and various points in the environment around the device 100.

FIG. 1B depicts exemplary components of the electronic device 100. In some embodiments, the electronic device 100 has a bus 112 that operatively couples an I/O section 114 with one or more computer processors 116 and a memory 118. The I/O section 114 can be connected to a display 120, which may have a touch-sensitive component 122 and, optionally, an intensity sensor 124 (e.g., contact intensity sensor). In addition, the I/O section 114 can be connected with a communication unit 126 for receiving application and operating system data, using, for example, Wi-Fi, Bluetooth, near field communication (NFC), cellular, and/or other wireless communication techniques. The electronic device 100 may include one or more user input mechanisms, including a first user input mechanism 128 and/or a second user input mechanism 130. The first user input mechanism 128 is, optionally, a rotatable input device or a depressible and rotatable input device, for example. The second user input mechanism 130 is, optionally, a button, in some examples. The electronic device 100 optionally includes various sensors, such as a GPS sensor 132, an accelerometer 134, a directional sensor 136 (e.g., compass), a gyroscope 138, a motion sensor 140, the camera module 102, and/or a combination thereof, all of which can be operatively connected to the I/O section 114.

The memory 118 of electronic device 100 can include one or more non-transitory computer-readable storage mediums, for storing computer-executable instructions, which, when executed by one or more processors 116, for example, can cause the processors 116 to perform the techniques that are described herein. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 116 can include, for example, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of electronic device 100, as well as to facilitate capturing of images and in-field calibration as described herein. The processor 116 may be referred to herein as processing circuitry.

As described herein, the term “processor” and “processing circuitry” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements. The electronic device 100 is not limited to the components and configuration of FIG. 1B, but can include other or additional components in multiple configurations.

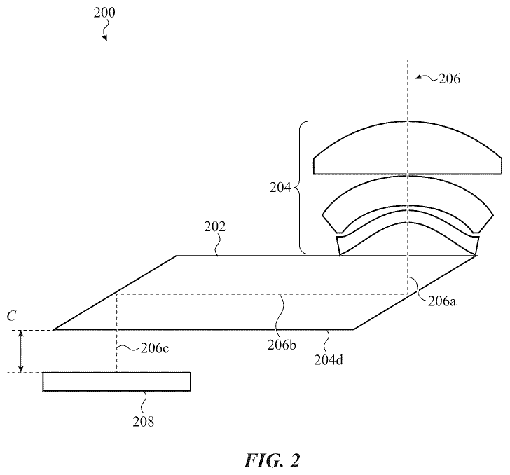

FIG. 2 shows a partial cross-sectional view of a camera module 200 which includes a prism 202, a lens assembly 204, and an image sensor 208. In this camera module 200, the lens assembly 204 and the image sensor 208 are positioned on opposite sides of the prism 202. Due to the folding optical configuration of the prism 202, light travels along an optical axis 206 that is folded in multiple directions. The optical axis 206 may have multiple segments 206a-206c. As shown, light travels along a first segment 206a of the optical axis 206 and enters the camera module 200 (e.g., through the lens assembly 204 and enters the folding prism 202 at a top surface). Then, light folds multiple times (e.g., along a second segment 206b of the optical axis 206 that is a positioned along a different direction than the first segment 206a and a third segment 206c of the optical axis 206 that is positioned along a different direction than the second segment 206b) within the prism 202 before exiting the prism 202 along the third segment 206c. At a third segment 206c, light exits the folding prism 202 (e.g., at a bottom surface opposite the top surface) and reaches the image sensor 208. In this configuration, the prism 202 is between the lens assembly 204 and the image sensor 208.

The camera module 200 may be configured to adjust focus by providing relative movement between the image sensor 208 and the prism 202 along the third segment 206c of the optical axis 206 (e.g., by moving the image sensor 208 relative to the prism 202). In some examples, the image sensor 208 may be coupled to an actuator that moves the image sensor 208 away and towards the prism 202. In other examples, an actuator may be coupled to the prism, which moves the prism away from the lens assembly 204 and towards the image sensor 208, or towards the lens assembly 204 and away from the image sensor 208. By positioning the image sensor beneath the prism 202, there is a clearance C between the prism 202 and the image sensor 208 that may add to the overall footprint of the camera module 200 along the third segment 206c of the optical axis 206. Instances where the prism 202 and image sensor 208 are moving relative to each other (e.g., for focusing purposes) may increase the size of the clearance C to accommodate this movement.

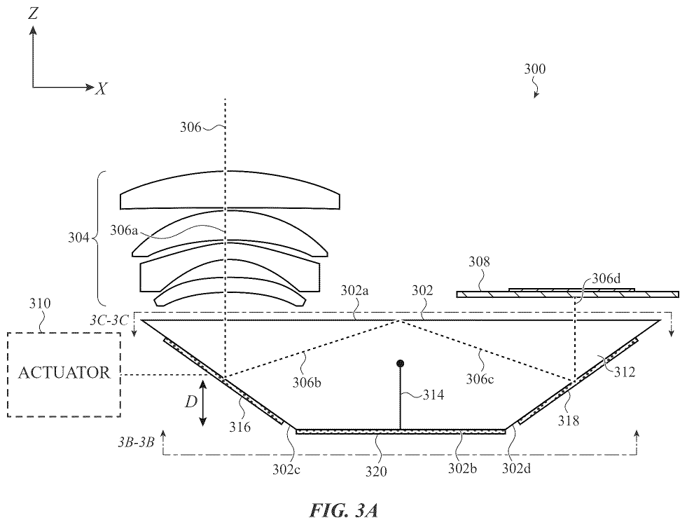

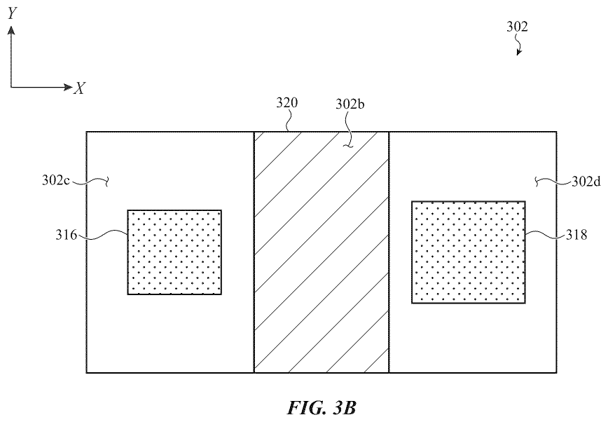

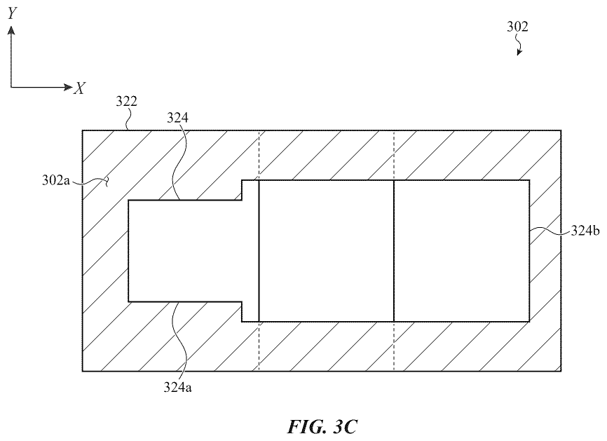

By contrast to FIG. 2, FIGS. 3A-3C show an example camera module 300 according to examples of the present disclosure. As depicted in FIG. 3A, the camera module 300 has a lens assembly 304 and an image sensor 308 positioned to a common side of a prism 302, which allows for a reduced form factor for a given focal length in the camera module 300 as compared to the camera module 200 of FIG. 2. Specifically, having the lens assembly 304 and the image sensor 308 positioned adjacent to a common surface may reduce the height of the camera module 300. As an additional benefit, in instances where the prism 302 is moveable (e.g., via an actuator 310), the prism 302 can be configured to move simultaneously away from the lens assembly 304 and away from the image sensor 308. This simultaneous movement may double the change in focal length for a given actuation distance as compared to the camera module 200 of FIG. 2.

The prism 302 may include a body 312 formed from an optically transparent material. In some instances, the optically transparent material includes glass, though in other variations other optically transparent materials, such as plastic, may be used to form the body. In some variations, the body 312 is formed from a monolithic piece. In other variations, the body 312 is assembled from multiple, separate pieces (each of which may be formed from the same optically transparent material or different optically transparent materials) that are connected to form the body 312.

The body 312 of the prism 302 may define, at least partially, each surface of the prism 302. In particular, the body 312 may have a first surface 302a. The first surface 302a is positioned such that the lens assembly 304 and the image sensor 308 are adjacent to this first surface and such that light is received/exits through the first surface 302a. In addition, the body 312 may define a second surface 302b of the prism 302 that is opposite the first surface 302a. In some embodiments, the first surface 302a is parallel to the second surface 302b, though it should be appreciated that in other instances the first surface 302a may be oblique to the second surface 302b.

In some embodiments, the body 312 may also define a third surface 302c and a fourth surface 302d. Each of the third and fourth surfaces 302c and 302d may define an oblique angle with respect to each of the first surface 302a and the second surface 302b. In some cases, a third surface 302c may be a first oblique surface and the fourth surface 302d may be a second oblique surface. In some cases, the third surface 302c connects the first surface 302a and the second surface 302b to each other. Similarly, the fourth surface 302d may connect the first surface 302a to the second surface 302b. In some cases, the third and fourth surfaces 302c and 302d may define an oblique angle with respect to each other. In other cases, the third and fourth surfaces 302c and 302d may define a right angle with respect to each other. In some instances (e.g., when the first and second surface 302a and 302b are parallel to each other), the surfaces 302a-d may define a trapezoid and the prism 302 may be a trapezoidal prism. While only surfaces 302a-d are depicted in FIG. 3A, a prism with additional surfaces, faces, and/or angles are envisioned. In some cases, the first surface 302a may be larger than the second surface 302b (e.g., with respect to a surface area). In some examples, third and fourth surfaces 302c and 302d may be the same size.

As depicted in FIG. 3A, the lens assembly 304 receives light from a scene (e.g., a user of a smart device taking a picture) and directs the light into the prism 302 along a first segment 306a of an optical axis 306 of the camera module 300. The lens assembly 304 may include a series of lenses that are coupled to each other (e.g., held in a fixed relationship with respect to each other, moveably coupled with respect to each other). The lens assembly 304 may be positioned within a lens barrel (not shown) of the camera module and positioned behind a cover window of the electronic device (e.g., electronic device 100 from FIG. 1A). The position of the lens assembly 304 is such that light from a scene that is received through the cover window is routed by the lens assembly 304 to the prism 302. Generally, the lenses of the lens assembly 304 are formed from one or more optically transparent materials, such as glass or plastic, which facilitate routing the light from the scene that is within the operating wavelength range of the camera module 300 to the prism 302 and then to the image sensor 308.

The prism 302 is configured such that light that is introduced into the prism through the first surface 302a from the lens assembly 304 is routed to exit the prism 302 at the first surface 302a. More specifically, the prism 302 receives the light traveling along a first segment 306a of the optical axis 306 at first surface 302a. Next, the light may travel within the prism 302, reach the third surface 302c, and reflect off of the third surface 302c. In some examples, as shown in a bottom view of the prism 302 in FIG. 3B, the third surface 302c may include a first reflective coating 316 over a portion of the third surface 302c, such that light incident on the first reflective coating 316 reflects off of the third surface 302c. In some variations, the first reflective coating 316 may be centrally positioned within the third surface 302c, such that the first reflective coating 316 does not reach the edges of the third surface 302c. In other variations, the first reflective coating 316 may extend to one or more edges of the third surface 302c. In some variations, a periphery of the third surface 302c (e.g., at least partially surrounding the first reflective coating 316) may be uncoated (e.g., such that a portion of the third surface 302c is defined by exposed material of the body 312). In other examples, the periphery of third surface 302c may include an opaque coating at least partially surrounding the first reflective coating 316 (e.g., partially or fully surrounding the first reflective coating 316) configured to prevent stray light from entering the prism through the third surface 302c. In some variations, the opaque coating may also be positioned at least partially over the first reflective coating 316.

Returning to FIG. 3A, subsequent to light reflecting from the third surface 302c, light may travel through the prism 302 (e.g., via a second segment 306b of the optical axis 306) and reach the first surface 302a. In some examples, at the first surface 302a, light is redirected again via total internal reflection. For example, an incident angle of the light may be steeper (e.g., larger with respect to a vertical, Z-axis) than a critical angle determined by a relationship between the refractive index of the prism 302 and air (or other outside medium). Once the light is reflected from the first surface 302a, the light may travel through the prism (e.g., via a third segment 306c of the optical axis 307) and may reach the fourth surface 302d. At the fourth surface 302d, light may be reflected again and travel through the prism 302 (e.g., via a fourth segment 306d of the optical axis 306).

As depicted in FIG. 3B, similar to the third surface 302c, the fourth surface 302d may include an additional second reflective coating 318. In some variations, the second reflective coating 318 may be centrally positioned within the fourth surface 302d, such that the second reflective coating 318 does not reach the edges of the fourth surface 302d. In other variations, the second reflective coating 318 may extend to one or more edges of the fourth surface 302d. In some variations, a periphery of the fourth surface 302d (e.g., at least partially surrounding the second reflective coating 318) may be uncoated (e.g., such that a portion of the fourth surface 302d is defined by exposed material of the body 312). In other examples, the periphery of fourth surface 302d may include an opaque coating at least partially surrounding the second reflective coating 318 (e.g., partially or fully surrounding the second reflective coating 318) configured to prevent stray light from entering the prism through the fourth surface 302d. In some variations, the opaque coating may also be positioned at least partially over the second reflective coating 318.

In some embodiments, a surface area of the first reflective coating 316 on the third surface 302c and a surface area of the second reflective coating 318 on the fourth surface 302d may be different. For example, to accommodate for changes in beam size of the light that ultimately reaches the image sensor 308, the first reflective coating 316 on the third surface 302c may be smaller than the reflective coating on the fourth surface 302d. The light beam that reaches the fourth surface 302d may be more spread out due to expansion of the collected light as it travels through the prism 302, and thus a larger area of coverage may be used at the fourth surface 302d. In some instances, the third surface 302c and the fourth surface 302d may have different angles with respect to the first surface 302a and/or different surface areas. Accordingly, the size of the reflective coating may vary proportionally with the size of the surface it covers. In some cases, the sizes of the first reflective coating 316 and the second reflective coating 318 may be the same.

Back to FIG. 3A, light reflected from the fourth surface 302d may then reach the first surface 302a, exit the prism 302, and reach the image sensor 308. As described herein, the image sensor 308 may be any suitable image sensor configured to generate one or more signals that convey information about light received. For example, the image sensor 308 may be a CCD, CMOS sensor, and the like.

In some examples, as shown in FIG. 3A, the prism 302 is configured such that the light enters the prism from the lens assembly 304 and reaches the image sensor 308 without reflecting from the second surface 302b. In some cases, the prism 302 is configured such that the light that reaches the image sensor 308 (e.g., the light for imaging purposes excluding stray light) does not reach the second surface 302b. In some instances, the second surface 302b may include an opaque coating 320 or other opaque structures which absorbs stray light, as shown in FIG. 3B.

In some embodiments, as shown in FIG. 3A, the prism 302 may include an opaque mask 314 that extends from the second surface 302b into the body 312. In some cases, the opaque mask 314 is coupled to the body 312 or portions of the body 312. In some variations, the opaque mask 314 may extend vertically (e.g., orthogonally from the second surface 302b) in a direction towards the first surface 302a. In some examples, the opaque mask 314 may extend obliquely from the second surface 302b in a direction towards the first surface 302a. In some examples, portions of the opaque mask 314 (e.g., viewed from a Y direction, not shown) may extend up to the first surface 302a. Additionally or alternatively, the opaque mask in a Y-axis (along the width of the prism 302) may extend over the full width of the body. In some cases, however, the width of the opaque mask may vary. For example, the opaque mask may include two portions positioned adjacent to a periphery of the body. In this configuration, the opaque mask is configured to absorb stray light at the edges of the body 312 while allowing light to travel through a central region of the body 312. In other cases, the opaque mask 314 may not extend to both edges or may extend to one edge of the body 312. Additional opaque coatings may be positioned over portions of the surfaces at the edges to prevent stray light from causing artifices in the image and/or to prevent external light from entering the prism.

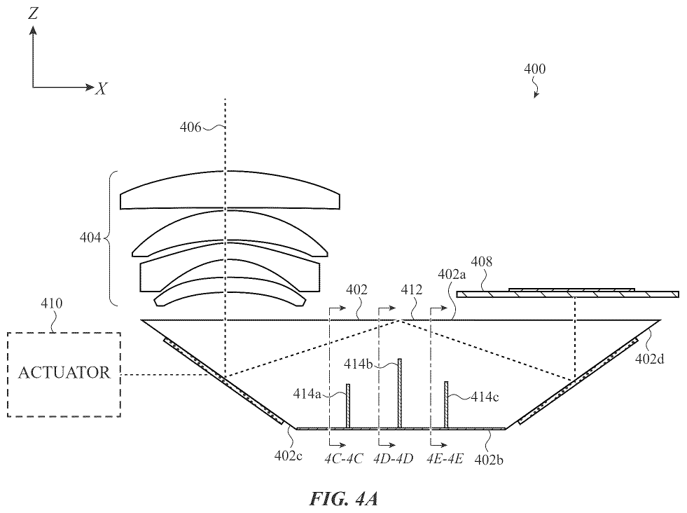

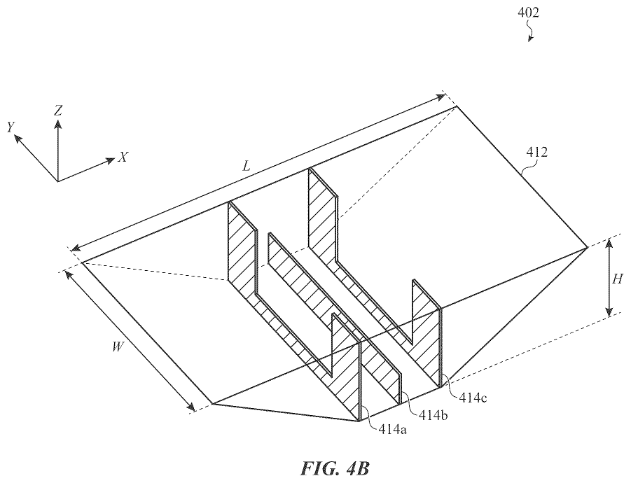

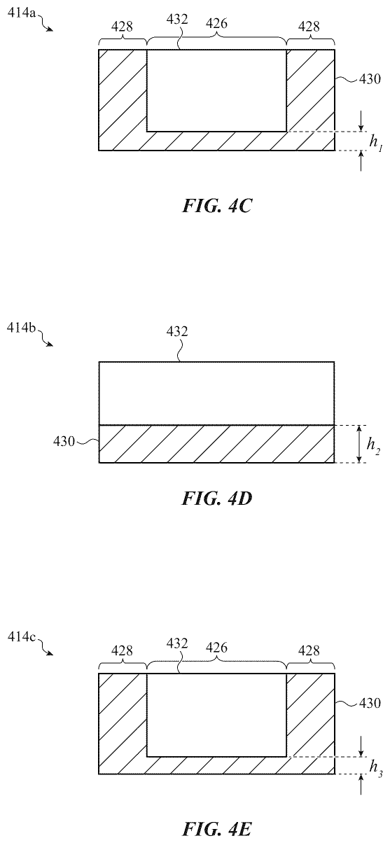

The prism 302 may define a light-blocking region and a light-transmitting region along the plane of the prism 302 in which the opaque mask 314 is located, such that light intersecting the plane either passes through the light-transmitting region or is blocked by the light-blocking region. In these instances, light that is passed through the prism 302 between the lens assembly 304 and the image sensor 308 may pass through the light-transmitting region. In instances where the prism 302 includes multiple opaque masks, each opaque mask may define a light-blocking region and a light-transmitting in a different corresponding plane of the prism 302. Examples of opaque masks that may be incorporated into the prism 302 are discussed herein with respect to FIGS. 4A-4E.

As described herein, the camera module 300 is configured such that the light entering the camera module 300 enters and exits the prism 302 at a common surface—e.g., the first surface 302a. FIG. 3C shows a plan view of the prism 302. In some variations, such as depicted, the first surface 302a may include an opaque coating 322. The opaque coating 322 may at least partially define one or more windows 324 in the first surface 302a through which light may enter or exit the prism 302. The opaque coating 322 may be configured to absorb light that is incident on the opaque coating 322. In this way, stray light that is incident on the opaque coating 322 (e.g., stray light that has already entered the prism 302 and/or stray light that is external to the prism) may be at least partially absorbed by the opaque coating 322. In this way, the opaque coating 322 may reduce the amount of stray light within the camera module 300 that reaches the image sensor 308.

In some variations, the opaque coating 322 is positioned along at least a portion of the periphery of the first surface 302a. In some of these variations, the opaque coating 322 is positioned to extend along the entire periphery of the first surface 302a. In these instances, the opaque coating 322 may define one or more windows 324 that are entirely surrounded by the opaque coating 322 (e.g., the window 324 does not extend to an edge of the first surface 302a). In other variations, the opaque coating 322 extends partially along the periphery of the first surface 302a. In these instances, the opaque coating 322 may define one or more windows 324 that extends to one or more edges of the first surface 302a. While a single window 324 is shown in FIG. 3C, it should be appreciated that in other instances the opaque coating 322 may at least partially define multiple separate windows in the first surface 302a.

In some variations, the window 324 may be an uncoated portion of the first surface 302a. In these instances, the optically transparent material forming the body 312 of the prism 302 may directly interface with any surrounding materials (e.g., air). In other variations, the window 324 may be at least partially covered with one or more coatings (e.g., one or more anti-reflective coatings) that still allow light to enter and/or exit the prism 302 through the window 324. Additionally, the opaque coating 322 may be configured to at least partially define a window 324 may have any suitable shape. In some variations, the window 324 may have a rectangular shape. In other variations, such as shown in FIG. 3C, the window 324 may have a shape that includes a first rectangular portion 324a having a first width along the Y-axis of the prism 302 and a second rectangular portion 324b having a larger second width along the Y-axis of the prism 302. In some of these variations, the prism 302 may be positioned such that the lens assembly 304 directs light toward the first rectangular portion 324a. In these instances, this light may enter the prism 302 through the first rectangular portion 324a of the window 324 and may exit the prism 302 (e.g., after reflecting within the prism 302 as described herein) through the second rectangular portion 324b. The change in width of the window 324 may accommodate changes in the width of the light as it travels through the prism 302.

In some variations, one or more components of the camera module 300 may be selectively moveable to provide for autofocus and/or optical image stabilization capabilities of the camera module 300. In some variations, the image sensor 308 may be selectively moveable (e.g., using an actuator) relative to the prism 302. For example, in some variations the image sensor 308 may be selectively moveable relative to the prism 302 along segment 306d (e.g., along the Z axis of the coordinate system shown in FIG. 3A) to provide optical image stabilization capabilities to the camera module. Additionally or alternatively, the camera module 300 may be configured selectively generate relative movement between the prism 302 and the image sensor 308 along segment 306d (e.g., the Z-axis). For example, in the variation shown in FIG. 3A, the camera module 300 may be configured to selectively move the prism 302 within the camera module 300. Specifically, the prism 302 may be coupled to an actuator 310. The actuator 310 may be configured to move the prism 302 in a direction D, which in the variation shown in FIG. 3A, is parallel to segment 306d. In some examples, the actuator 310 is operable to move the prism 302 relative to both the lens assembly 304 and the image sensor 308 simultaneously. Accordingly, the track length needed to move the prism 302 is half in this configuration compared to systems with an equivalent focal length. This configuration can result in an overall height reduction of the camera module 300 because less travel distance for the actuator is used to achieve equivalent focal length.

In some instances, the lens assembly 304 and the image sensor 308 may be coupled to a fixed portion of a housing of the camera module 300, while the actuator 310 and the prism 302 may be positioned within a receptacle or carrier within the housing that is moveably coupled with respect to its fixed portions. In some examples, the lens assembly 304 and/or the image sensor 308 may independently moveable with respect to each other and with respect to the prism 302.

In other examples, the image sensor 308 or the lens assembly 304 may be configured to move with the prism 302. For example, in some variations, actuator 310 may be configured to move the image sensor 308 and the prism 302 together with respect to the lens assembly 304. In another example, the actuator 310 may be configured to move the lens assembly 304 and the prism 302 relative to the image sensor 308.

In some embodiments, the actuator 310 may include a voice coil motor (VCM), a comb drive, or the like. For example, the actuator 310 may include a magnet that is fixed relative to the prism 302 (e.g., coupled to a carrier that carries the prism 302) and a coil configured to move the magnet via Lorentz forces along an axis (e.g., to move the prism 302 along direction D, which may be parallel to the first and fourth segments 306a, 306d of the optical axis 306). In some examples, the actuator 310 may include ball bearings, an alignment assembly, and the like, to guide the movement of a carrier carrying the prism 302. The actuator 310 may include any suitable actuator configuration as will be readily understood by someone of ordinary skill in the art.

While the embodiment of the prism 302 shown in FIGS. 3A-3B is depicted as including a single opaque mask 314 that extends into the body 312 of the prism 302, FIGS. 4A-4E depict aspects of a variation of a camera module 400 that has a prism 402 with a plurality of opaque masks 414a-414c extending into a body 412 of the prism 402. Specifically, FIG. 4A shows an elevation view of the camera module 400 and the prism 402. The camera module 400 may be otherwise configured in any manner as described herein with respect to the camera module 300 of FIGS. 3A-3C. For example, the variation of the camera module 400 shown in FIG. 4A includes a lens assembly 404, an image sensor 408, and an actuator 410. Similarly, the prism 402 may be positioned and configured to operate in the same manner as prism 302 of the camera module 300 of FIGS. 3A-3C. Specifically, the prism 402 may be configured to receive light from the lens assembly 404 through a first surface 402a of the prism, fold the light along multiple segments 406, and to direct light to exit the prism 402 through the first surface 402a. The camera module 400 may be configured such that this light, after exiting the first surface 402a of the prism 402, is directed to the image sensor 408.

In the embodiments shown in FIGS. 4A-4E, a plurality of opaque masks 414a-414c includes three opaque masks (e.g., a first opaque mask 414a, a second opaque mask 414b, and a third opaque mask 414c). Each of the first, second, and/or third masks 414a-414c may be part of the prism 402 and may be coupled to the body 412 in any manner as described herein. The first, second, and/or third masks 414a-414c are positioned along a second surface 402b and extend into the body 412 (e.g., toward a first surface 402a) such that stray light is absorbed and blocked while the light that enters and exits the prism 402 to generate the image does not reach any of the first, second, or third opaque masks 414a-414c. In some embodiments, the first opaque mask 414a is positioned between the third surface 402c and the second opaque mask 414b. In some cases, the first opaque mask 414a may be closer in distance with respect to the third surface 402c as compared to the fourth surface 402dd. The second opaque mask 414b may be between the first opaque mask 414a and the third opaque mask 414c. The third opaque mask 414c may be between the fourth surface 402d and the second opaque mask 414b. In some cases, the third opaque mask 414c may be closer in distance with respect to a fourth surface 402d as compared to the third surface 402c. In terms of travel direction of the light entering the prism 402 from the lens assembly 404, light will travel first through a first light-transmitting region defined by first opaque mask 414a is first, then through a second light-transmitting region defined by the second opaque mask 414b, and then through a third light-transmitting region defined by the third opaque mask 414c, before exiting the prism 402.

FIG. 4B shows a perspective view of prism 402. In this view, reflective coatings and/or opaque coatings that may be coupled to surfaces 402a-402d are omitted for clarity. As depicted, each the first, second, and third opaque masks 414a-414c may extend along at least a portion of the width W across the body 412 (e.g., along a Y-axis) of the prism 402. In addition, each the first, second, and third opaque mask 414a-c may be separated along the length L, defined along an X-axis, of the prism 402 and, more specifically, along a length of the second surface 402b (along the X-axis). In this configuration, the each the first, second, and third opaque masks 414a-414c are positioned crosswise with respect to the length of the prism 402, such that the light traversing the prism 402 (e.g., received by the lens assembly 404 and directed to the image sensor 408) along certain trajectories pass above each of the plurality of opaque masks 414a-414c. Stray light traversing the prism along undesirable trajectories be blocked by one of the plurality of opaque masks 414a-414c.

FIGS. 4C-4E show cross-sectional views of the first, the second, and the third opaque masks 414a-414c, respectively. As depicted, each of the first, second, and/or third opaque masks 414a-414c may define have different patterns configured to block stray light from different regions/portions of the prism 402 to reduce glare. For example, FIG. 4C depicts a first opaque mask 414a that defines a “U” shape, in which a central portion 426 (having a first height h₁) is positioned between peripheral portions 428. In some cases, opaque masks portions at the peripheral portions 428 may have a respective second height that is greater than the first height h₁. At the central portion 426 of the first opaque mask 414a, an optically transparent material 432 may extend from the first surface 402a (see FIG. 4A) up to a boundary with the opaque material 430. Similarly, the third opaque mask 414c depicted in FIG. 4E may have a similar “U” shape with a height h₃ at the central portion 426 being less than a height at the peripheral portions 428 of the prism 402. In some examples, heights h₁ and h₃, may be different. In other examples, heights h₁ and h₃ may be the same. The third opaque mask 414c region may also define an optically transparent material 432 extending up to a boundary with the opaque material 430. Generally, the light which reaches the image sensor travels through the optically transparent material 432. Stray light (e.g., from external sources, and the like), by contrast, is blocked by the opaque material 430. The optically transparent material 432 from FIGS. 4C and 4E may be the same as the optically transparent material as the body 412. In some examples, as depicted, a respective height of the opaque material 430 at the peripheral portions 428 may be the height H (see FIG. 4B) of the prism 402. For example, at each of the peripheral portions 428, the opaque material 430 from the first opaque mask 414a may extend from a first surface 402a of the prism 402 to the second surface 402b of the prism 402. The third opaque mask 414c may have a similar shape as that described for the first opaque mask 414a. Due to this shape, stray light traveling close to edges (e.g., sides, surfaces) of the prism 402 is blocked, helping to further reduce potential glare and/or other artifices in the image.

As depicted in FIG. 4D, an opaque mask (e.g., second opaque mask 414b) may be a rectangular shape. For example, the second opaque mask 414b may extend a uniform height h₂ along the width of the prism. In some embodiments, h₂ may be larger than h₁ and h₃ (e.g., at the central portion 426). In other examples, h₂ may be the same as h₁ and h₃ (e.g., at the central portion). Similar to the first opaque mask 414a and the third opaque mask 414c described above, an optically transparent material 432 may extend between the first surface 402a (reference to FIG. 4A) up to a boundary with the opaque material. The opaque material 430, in turn, may extend from the boundary to the second surface 402b (see FIG. 4A). In some cases, the height and shape of each of the opaque masks 414a-414c may depend on the opaque material 430 used and/or other variables, such as size, in the prism 402.

These foregoing embodiments depicted in FIGS. 1A-4E and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. A camera module comprising:
a prism comprising:
a body formed from an optically transparent material, the body defining:
a first surface; and
a second surface opposite the first surface;
a lens assembly positioned to direct light from a scene to the first surface of the body;
an image sensor positioned to receive light directed through the prism that exits from the first surface of the body; and
an actuator coupled to the prism and configured to move the prism relative to both the lens assembly and the image sensor.

2. The camera module of claim 1, wherein:
the body further defines:
a third surface oblique to the first and second surfaces, the third surface connecting the first surface to the second surface; and
a fourth surface oblique to the first and second surfaces; and
the third and fourth surfaces are configured to reflect light traveling through the prism.

3. The camera module of claim 2 wherein the third surface is oblique to the fourth surface.

4. The camera module of claim 1, wherein the prism further comprises a first opaque mask extending into the body from the second surface.

5. The camera module of claim 4, wherein:
the prism comprises a plurality of opaque masks;
the plurality of opaque masks includes the first opaque mask; and
each opaque mask of the plurality of opaque masks extends towards the body from the second surface of the prism.

6. The camera module of claim 1, wherein the actuator comprises a voice coil motor.

7. The camera module of claim 1, wherein the optically transparent material comprises glass.

8. A camera module comprising:
an prism comprising:
a body formed from an optically transparent material, the body defining:
a first surface;
a second surface opposite the first surface; and
an opaque mask extending into the body from the second surface;
lens assembly configured to direct light from a scene to the first surface of the body; and
an image sensor configured to receive light directed through the prism that exits from the first surface of the body.

9. The camera module of claim 8, wherein the opaque mask has a rectangular shape.

10. The camera module of claim 8, wherein:
the opaque mask is a first opaque mask;
the prism further comprises a second opaque mask and a third opaque mask, each the first and the second opaque masks extend into the body from the second surface; and
the first, second, and third opaque masks are laterally spaced along the second surface.

11. The camera module of claim 10, wherein:
the body defines:
a third surface oblique to the first and second surfaces; and
a fourth surface oblique to the first and second surfaces, the third surface positioned such that light entering the first surface from the lens assembly is directed toward the third surface;
the first opaque mask is positioned between the third surface and the second opaque mask; and
the third opaque mask is positioned between the second opaque mask and the fourth surface.

12. The camera module of claim 11, wherein a height of a portion of the second opaque mask is less than a respective height of each of a portion of the first opaque mask and a portion of the third opaque mask.

13. The camera module of claim 11, wherein:
the first opaque mask defines a central portion and a peripheral portion; and
the central portion has a height less than a height of the peripheral portion.

14. The camera module of claim 13, wherein the height of the peripheral portion is a same height as the body.

15. A camera module comprising:
a lens assembly;
an image sensor;
an prism positioned to receive light from a scene via the lens assembly and to transmit light through the prism to the image sensor, the prism defining:
a first surface;
a second surface opposite the first surface;
a third surface oblique to the first and second surfaces; and
a fourth surface oblique to the first and second surfaces, wherein:
the prism is configured such that when the light is received from the lens assembly:
the light enters the prism through the first surface;
the light, after entering the prism through the first surface reflects from the third surface toward the first surface;
the light, after reflecting from the third surface, reflects from the first surface toward the fourth surface;
the light, after reflecting from the first surface, reflects from the fourth surface toward the first surface; and
the light, after reflecting from the fourth surface, exits the prism through the first surface.

16. The camera module of claim 15, wherein at least a portion of a periphery of the first surface is covered by an opaque coating.

17. The camera module of claim 16, wherein:
the opaque coating is a first opaque coating; and
the prism further comprises a second opaque coating covering the second surface.

18. The camera module of claim 17, wherein:
the prism further comprises:
a first reflective coating covering at least a first portion of the third surface of the prism; and
a second reflective coating covering at least a first portion of the fourth surface of the prism.

19. The camera module of claim 18, wherein the prism comprises:
a third opaque coating covering a second portion of the third surface of the prism and at least partially surrounding the first reflective coating; and
a fourth opaque covering a second portion of the fourth surface of the prism and at least partially surrounding the second reflective coating.

20. The camera module of claim 15, wherein the prism comprises:
a body defining the first, second, third, and fourth surfaces; and
a plurality of opaque masks extending towards the body from the second surface of the prism between the third and fourth surfaces.
